(19) United States
(12) Patent Application Publication
(10) Pub. No.: US 2020/0202133 A1
(43) Pub. Date: Jun. 25, 2020

(54) PEDESTRIAN TRACKING SYSTEM AND METHOD

(71) Applicant: Continental Automotive Systems Inc., Auburn Hills, MI (US)

(72) Inventor: Elena Quijano, Soquel, CA (US)

(21) Appl. No.: 16/275,530

(22) Filed: Feb. 14, 2019

Related U.S. Application Data
(60) Provisional application No. 62/783,626, filed on Dec. 21, 2018.

(51) Int. Cl. G06K 9/00; G06Q 30/02

(52) U.S. Cl. CPC G06K 9/00771; G06Q 30/0201; G06K 9/00335

(57) ABSTRACT

A system for tracking pedestrians includes a detector configured to be mounted to an infrastructure component and configured to detect a pedestrian. A computing module is in communication with the detector and is configured to gather information from the sensor about the pedestrian.

### PRIORITY CLAIM

This application claims the benefit of U.S. Provisional Application No. 62/783,626 filed on Dec. 21, 2018.

### BACKGROUND

Environmental sensor systems may gather data regarding a particular environment, such as information regarding a number of pedestrians detected in the particular environment. These sensor systems may include various types of sensors that are mounted to infrastructure (traffic lights, signs, parking meters, etc.) near intersections, along roads, and on buildings.

### SUMMARY

In one exemplary embodiment, a system for tracking pedestrians includes a detector configured to be mounted to an infrastructure component and configured to detect a pedestrian. A computing module is in communication with the detector and is configured to gather information from the sensor about the pedestrian.

In a further embodiment of any of the above, the detector is a camera.

In a further embodiment of any of the above, the detector is configured to detect a gaze of the pedestrian.

In a further embodiment of any of the above, the system is configured to detect whether the gaze of the pedestrian is directed to a particular area of interest.

In a further embodiment of any of the above, the system is configured to detect how long the pedestrian looks at the particular area of interest.

In a further embodiment of any of the above, the system is configured to detect a plurality of pedestrians and a percentage of the plurality of pedestrians that look at the particular area of interest.

In a further embodiment of any of the above, the particular area of interest is one of a cross walk, a building, a sign, and an advertisement.

In a further embodiment of any of the above, the system is configured to detect an amount of time a pedestrian spends near the infrastructure component.

In a further embodiment of any of the above, the system is configured to detect a number of pedestrians near the infrastructure component over a period of time.

In a further embodiment of any of the above, the period of time is a day.

In a further embodiment of any of the above, the infrastructure component is one of a traffic light, a building, a street light, a sign, a parking meter, and a telephone pole.

In a further embodiment of any of the above, the computing module is programmed with data regarding a surrounding environment.

In a further embodiment of any of the above, the data comprises information about at least one of a particular area of interest, a cross walk, a building, a sign, and an advertisement.

In a further embodiment of any of the above, the computing module is mounted on the infrastructure component.

In another exemplary embodiment, a method for tracking pedestrians includes mounting a detector on an infrastructure component. A pedestrian is identified near the infrastructure component with the detector and a gaze of the pedestrian is tracked.

In a further embodiment of any of the above, it is determined whether the gaze of the pedestrian is directed to a particular area of interest.

In a further embodiment of any of the above, it is determined how long the pedestrian looks at the particular area of interest.

In a further embodiment of any of the above, a plurality of pedestrians is identified and a percentage of the plurality of pedestrians that look at the particular area of interest is determined.

In a further embodiment of any of the above, it is determined how long the pedestrian spends near the infrastructure component.

In a further embodiment of any of the above, it is determined a number of pedestrians near the infrastructure component over a period of time.

### BRIEF DESCRIPTION OF THE DRAWINGS

The disclosure can be further understood by reference to the following detailed description when considered in connection with the accompanying drawings wherein:

FIG. 1 schematically illustrates an example smart infrastructure system.

### DETAILED DESCRIPTION

The subject invention provides a system and method that includes mounting one or more detectors to an infrastructure component, determining positioning and marking areas of interest in the environment, and tracking pedestrians, including pedestrian gaze. For example, the system and method may be calibrated to incorporate data regarding the environmental infrastructure, including intersections, sidewalks, cross-walks, parking spaces, and buildings. The system may also be calibrated to incorporate data regarding a particular area of interest, such as a sign or advertisement. The system and method track pedestrians to determine data such as a number of pedestrians, the length of time each pedestrian spends in the environment, the number of pedestrians that look at the area of interest, and the length of time spent by pedestrians looking at the area of interest.

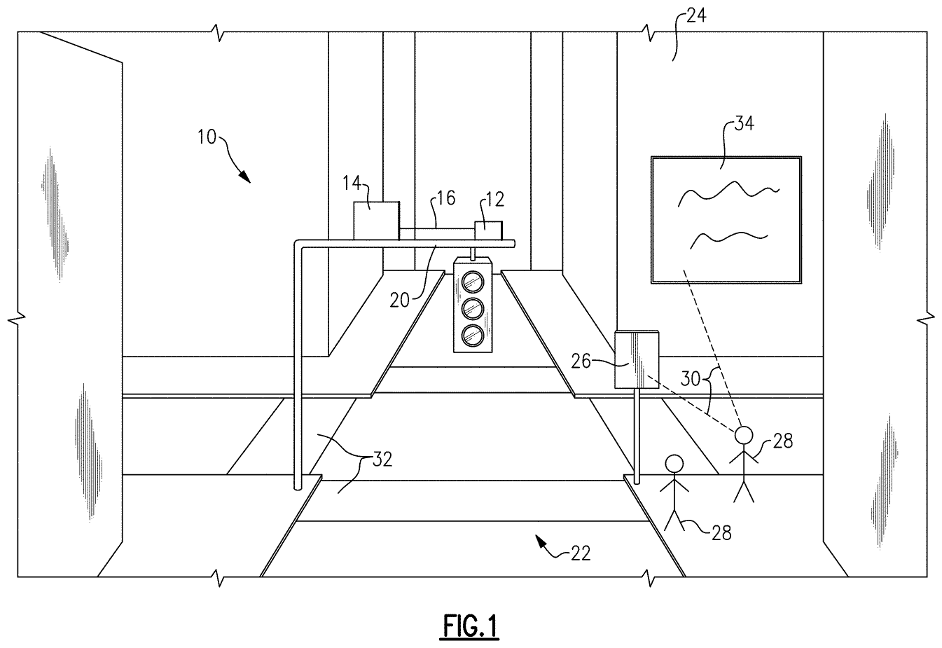

FIG. 1 illustrates an example smart infrastructure system 10. The system 10 generally includes a detector 12 and a computing module 14 connected via communication hardware 16. In the illustrated example, the system 10 is mounted on a traffic light 20 at an intersection 22. In other examples, the system 10 may be mounted on a building 24, a street light, a sign 26, a parking meter, a telephone pole, or other structure in an area where there may be pedestrians 28. In further examples, the system 10 may be mounted across multiple structures. For example, the system 10 may include a detector 12 on a traffic light 20 and the computing module 14 on a nearby building 24. In a further example, the system 10 may include multiple detectors 12 mounted on the same or different structures, each of the detectors 12 in communication with the computing module 14. Although communication hardware 16 is illustrated, the detector 12 and computing module 14 may communicate wirelessly. The system 10 generally tracks pedestrians 28, and may be located anywhere that pedestrian detection and tracking may be useful.

The detector 12 detects and tracks pedestrians 28. The detector 12 may be a camera, for example. In particular, the detector 12 can track the gaze 30 of the pedestrian 28, that is, the direction the pedestrian 28 is looking. The system 10 may employ a neural network for pedestrian detection. The system 10 employs vision algorithms on detected pedestrians 28 to compute and track gaze 30.

The computing module 14 may be calibrated to have data regarding the surrounding environment, such as the intersection 22. For example, the computing module 14 may be calibrated to have information regarding cross walks 32, buildings 24, signs 26, and other areas of interest such as advertisements 34. Thus, the system 10 is calibrated to determine positioning and mark areas of interest in the environment.

The system 10 uses the gaze detection of the detector 12 to compute metrics regarding pedestrians 28. The system 10 uses the information regarding positioning and areas of interest in the environment to track pedestrians 28 in the environment. For example, the system 10 may compute the number of pedestrians 28 in a particular area over a certain length of time, such as per day. The system 10 may compute the length of time an individual pedestrian 28 spends in a particular area. The system 10 may detect which pedestrians 28 look at a particular area of interest, such as a sign 26 or advertisement 34. The system 10 may further compute the percentage of pedestrians 28 that look at the area of interest. The system 10 may compute the amount of time a pedestrian 28 spends looking at the area of interest.

This information regarding the pedestrian's interaction with areas of interest in the environment is determined by the detector 12 sending information to the computing module 14, which further computes valuable metrics. The detector 12 may communicate with the computing module 14 via communication hardware 16, or may communicate wirelessly. The system 10 may use one or more of the following connection classes, for example: WLAN connection, e.g. based on IEEE 802.11, ISM (Industrial, Scientific, Medical Band) connection, Bluetooth® connection, ZigBee connection, UWB (ultrawide band) connection, WiMax® (Worldwide Interoperability for Microwave Access) connection, infrared connection, mobile radio connection, and/or radar-based communication.

The system 10, and in particular the computing module 14, may include one or more controllers comprising a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The computing module 14 may include a hardware device for executing software, particularly software stored in memory, such as the computer vision algorithm. The computing module 14 may include a custom made or commercially available processor, a central processing unit (CPU), an auxiliary processor among several processors associated with the computing module 14, a semiconductor based microprocessor (in the form of a microchip or chip set), or generally any device for executing software instructions. The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The controller can be configured to execute software stored within the memory, to communicate data to and from the memory, and to generally control operations of the computing module 14 pursuant to the software. Software in memory, in whole or in part, is read by the processor, perhaps buffered within the processor, and then executed. This software may be used to determine particular metrics about the pedestrians 28 in a particular environment, for example.

As discussed above, the system 10 uses cameras to observe pedestrian behavior patterns, including tracking pedestrian gaze. This is beneficial over other concepts that track pedestrians at intersections, as it provides additional information regarding the pedestrians, such as where they are looking. The system 10 may compute metrics such as a number of pedestrians 28 per day, the length of time a pedestrian 28 spends near the infrastructure, the percentage of pedestrians 28 who look at a particular area of interest, such as a sign 26 or advertisement 34, and the amount of time each pedestrian 28 spends looking at the particular area of interest. This information may be useful for applications such as improving infrastructure signage and signaling. For example, the system 10 may determine that very few pedestrians 28 notice a particular important sign 26. This may be improved by moving the sign 26 to a place where pedestrians 28 are looking, or by increasing the visibility and/or noticeability of the sign 26. The system 10 may also be useful for tracking pedestrians 28 viewing advertisements 34, and for improving the location and effectiveness of advertisements 34.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A system for tracking pedestrians, comprising:
a detector configured to be mounted to an infrastructure component and configured to detect a pedestrian;
a computing module in communication with the detector and configured to gather information from the sensor about the pedestrian.

2. The system of claim 1, wherein the detector is a camera.

3. The system of claim 1, wherein the detector is configured to detect a gaze of the pedestrian.

4. The system of claim 3, wherein the system is configured to detect whether the gaze of the pedestrian is directed to a particular area of interest.

5. The system of claim 4, wherein the system is configured to detect how long the pedestrian looks at the particular area of interest.

6. The system of claim 4, wherein the system is configured to detect a plurality of pedestrians and a percentage of the plurality of pedestrians that look at the particular area of interest.

7. The system of claim 4, wherein the particular area of interest is one of a cross walk, a building, a sign, and an advertisement.

8. The system of claim 1, wherein the system is configured to detect an amount of time a pedestrian spends near the infrastructure component.

9. The system of claim 1, wherein the system is configured to detect a number of pedestrians near the infrastructure component over a period of time.

10. The system of claim 9, wherein the period of time is a day.

11. The system of claim 1, wherein the infrastructure component is one of a traffic light, a building, a street light, a sign, a parking meter, and a telephone pole.

12. The system of claim 1, wherein the computing module is programmed with data regarding a surrounding environment.

13. The system of claim 12, wherein the data comprises information about at least one of a particular area of interest, a cross walk, a building, a sign, and an advertisement.

14. The system of claim 1, wherein the computing module is mounted on the infrastructure component.

15. A method for tracking pedestrians, comprising:
mounting a detector on an infrastructure component;
identifying a pedestrian near the infrastructure component with the detector; and
tracking a gaze of the pedestrian.

16. The method of claim 15, comprising determining whether the gaze of the pedestrian is directed to a particular area of interest.

17. The method of claim 16, comprising determining how long the pedestrian looks at the particular area of interest.

18. The method of claim 16, comprising identifying a plurality of pedestrians and determining a percentage of the plurality of pedestrians that look at the particular area of interest

19. The method of claim 15, comprising determining how long the pedestrian spends near the infrastructure component.

20. The method of claim 15, comprising determining a number of pedestrians near the infrastructure component over a period of time.
